(19) United States
(12) Patent Application Publication
(10) Pub. No.: US 2020/0218219 A1
(43) Pub. Date: Jul. 9, 2020

(54) Automated method for verifying manufacturing process control interlocks

(71) Applicant: David Thomas Boudreau, Fairfield, ME (US)

(72) Inventor: David Thomas Boudreau, Fairfield, ME (US)

(21) Appl. No.: 16/416,231

(22) Filed: Jun. 24, 2019

Related U.S. Application Data
(60) Provisional application No. 62/788,878, filed on Jan. 6, 2019.

(51) Int. Cl. G05B 19/042

(52) U.S. Cl. CPC G05B 19/0428; G05B 2219/21159

(57) ABSTRACT

The present invention discloses a method for automating process control interlock testing, verification and documentation. Various control system entities can be utilized by a created control system program that understands the required response of the control system to various operating conditions and interlocks. By continuously monitoring control system entities the created program evaluates the control systems ability to shut down the process and equipment. The automated method verifies that all utilized control system programming, software, hardware, communicated and/or hardwired interconnections are working properly. The automated method and continuous monitoring can determine that an interlock is incapable of shutting down the process as required and can notify the operator of a failed or malfunction interlock. A created control system program can provide historical data to an operator interface to for the purpose of documenting which interlocks were verified by the control system and which had initiated a shutdown of the process. The technical solution of the present invention provides the earliest detection of a failed or compromised interlock.

### BACKGROUND

Process control system interlocks need to be tested on a frequent basis to ensure the interlock can shut down the equipment and process to avoid operating the process equipment in an unsafe manner.

Traditional interlock functional testing such as recommended by Black Liquor Recovery Boiler Advisory Committee Instrumentation Checklist and Classification Guide requires creating or simulation process control conditions that initiate a response from the control system to verify that the interlock and control system has the ability to shut down the process. It is acceptable to test one interlock all the way through to the initiation of equipment shutdown and movement of the final controlled equipment to a safe state or desired position. Other interlocks that would also initiate the same process shutdown can be tested to common logic of the control system. Such traditional interlock testing only proves the interlock and control system can properly shutdown the process and related process equipment at that particular time when the interlock was tested.

The technical solution of the present invention solves the problem with traditional interlock testing, that a discovery of malfunctioning interlocks will only take place during scheduled testing, instrument calibrations or when the interlock fails to shut down the process which may result in damage to the equipment or injury to operating personnel. Interlock testing is required and/or recommended by those involved in manufacturing processes including insurance companies. Control system interlock testing is costly due to loss of manufacturing time and downtime of the process.

### BRIEF SUMMARY OF THE INVENTION

The invention is a method used to enable a modern control system to continuously monitor itself to document and verify that the control system interlocks are functioning as designed and can shut down the process when needed. The invented method enables the control system to detect any malfunctioning interlock. The new interlock verification method was bought to fruition with the creation of a control system program referred to as a Control System Interlock Monitor. This method can be utilized by any type of control system that provides the user with the ability to create control system entities and customs interlock monitoring programs for any type of process. The control system can utilize information provided by control system processors and logic solvers that react to various conditions of the devices used for the interlocks. The interlocks can be comprised of programming, software logic and settings, hardware, hardwired and communicated interconnections between the various control system processors and equipment. Control system entities can be created and utilized by the created monitoring program to show the operating state of the interlock at various locations of the control system. By monitoring such control system entities, the created program can determine if an interlock has malfunctioned and no longer has the ability preform the intended function of shutting down the process. The created program offers continuous monitoring of the control system interlocks and can activate an alarm to notify the operator when an interlock malfunction is detected by the monitoring program. The invented method of automating the interlock verification includes features of the created program to supply historical data to an operator interface to show results of the control system interlock monitoring and verification. Such automated interlock verification can be combined with routine instrument calibration and operational checks of equipment to ensure the interlocks and programming are properly functioning as designed.

### BRIEF DESCRIPTION OF THE DRAWINGS

FIG. 1. FIG. 1 presents a simplified overview of any type of process control system that includes multiple processors and interconnections. FIG. 1 also includes two examples of process equipment, a furnace draft transmitter and a fuel valve that will be referenced by this document to explain how the invention is utilized.

FIG. 2. FIG. 2 illustrates a more detailed summary of the control system example and how the invention is applied to the created Control System Interlock Monitor program.

FIG. 3. FIG. 3 presents a flow diagram that illustrates an example of the Control System Interlock Monitor programming, this specific example shows monitor logic for a high furnace draft interlock.

FIG. 4. FIG. 4 presents a flow diagram that illustrates an example of the Control System Interlock Monitor programming, this specific example shows the monitoring logic for a fuel valve and master fuel trip interlock.

FIG. 5. FIG. 5 presents an example of an operator interface display which shows the results of the created interlock monitoring program.

### DETAILED DESCRIPTION AND BEST MODE OF IMPLEMENTATION

The invented method of automating interlock verification can be applied to any control system that has the capability of monitoring the control system interlocks. This disclosure exemplifies the principles of the invention and is not considered to limit to the broader aspects of the invention to the particular embodiment as described.

The new method requires the user create a Control System Interlock Monitoring program. The created program gives the control system the ability to continuously monitor its response to various operating conditions and state changes of the interlocks. The created program can be structure text or other types of programming that are available to the programmer and inherent to the process control system in use. The created program must perform all the functions that would be included in traditional interlock testing, such as documenting and verifying the proper control system response. The programmer needs to understand the methods of programing for the particular control system in use and how the control system interlocks are configured to initiate a shutdown of the process and equipment. The created program will monitor all installed interlocks and present the results of this monitoring to an operator interface which is also created by the programmer. The operator interface will be utilized for recording number of interlock state changes, time and date the control system verified the interlock state change and if the interlock was responsible of initiating a shutdown of the process. The programmer will use or create various control system entities that represent conditions of the interlock and programmed logic at various locations within the control system. By utilizing these control system entities, the created program can determine if the control system is functioning as designed and has the ability to shut down the process if needed.

The created program also uses internal variables which are set by the created program. The internal values retain the last known state of the interlock so that subsequent execution by the created program can determine if the interlock has recently changed state. The program will solve or execute its program on a frequent basis as determine by the programmer. In response to a state change of the interlock, the created program will increment a counter for that particular interlock. The counter is used by the operator interface to show that the interlock has changed state.

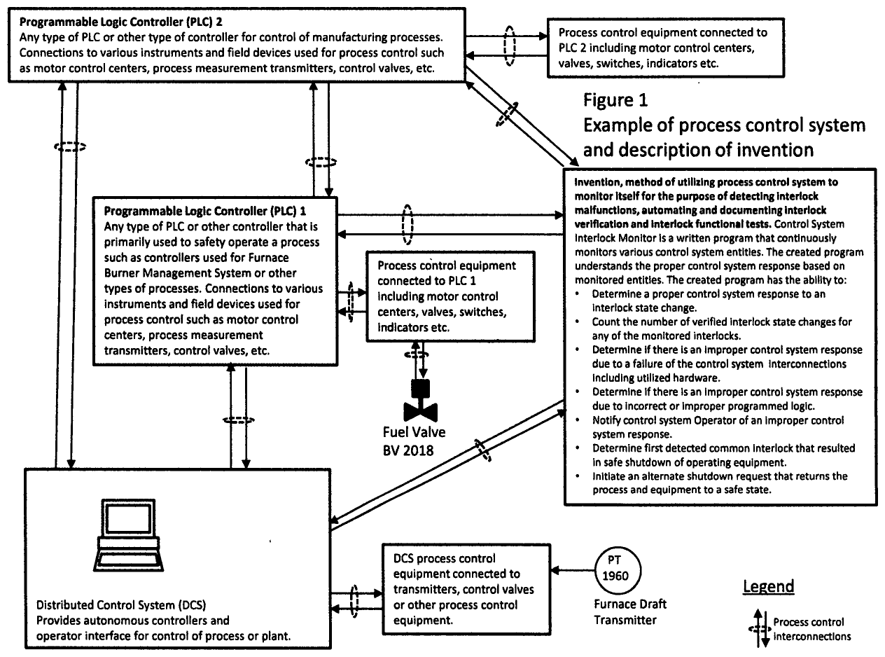

FIG. 1 is an example of a modern control system. In this figure the overall process control system is comprised of multiple logic solvers and processors and an assortment of utilized equipment such as a Distributed Control System (DCS) and Programmable Logic Controllers (PLCs) input and output cards and connections. Often with such designs there are interconnections, interlock devices such as pressure transmitters, temperature switches or similar instruments are connected to one controller or processor and used by other control system processors, controllers and logic solvers. In order to apply the invention, it is not a requirement that the control system have multiple processors or logic solvers. Multiple control system entities for one processor can also be monitored to determine if the interlock and control system logic is responding appropriately.

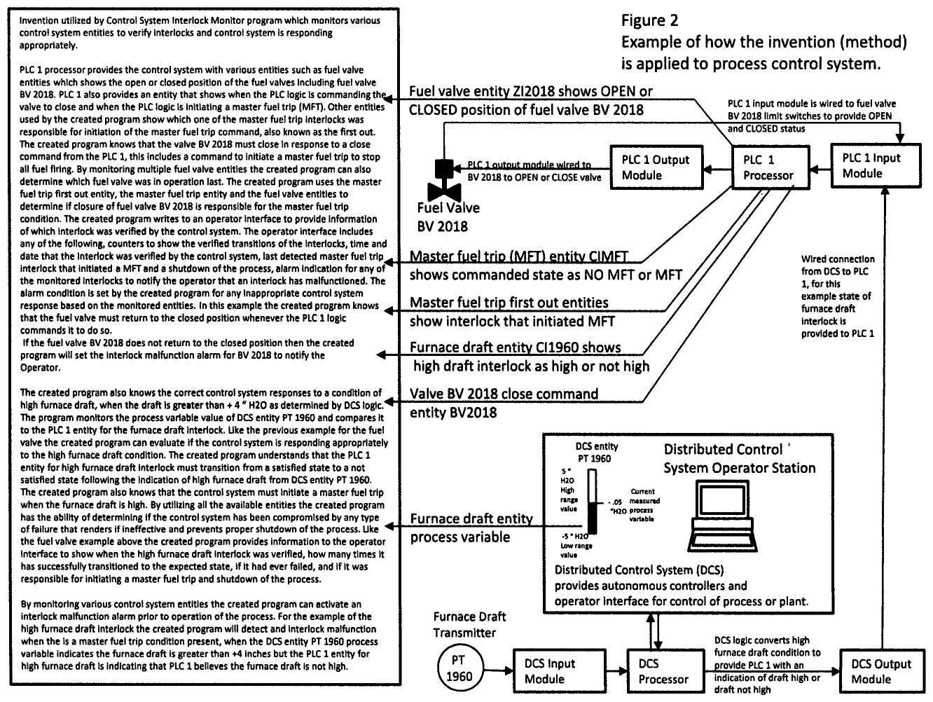

FIG. 2 provides more detailed information for the control system example shown on FIG. 1. FIG. 2 also includes text that describes the overall purpose and use of the various control system entities.

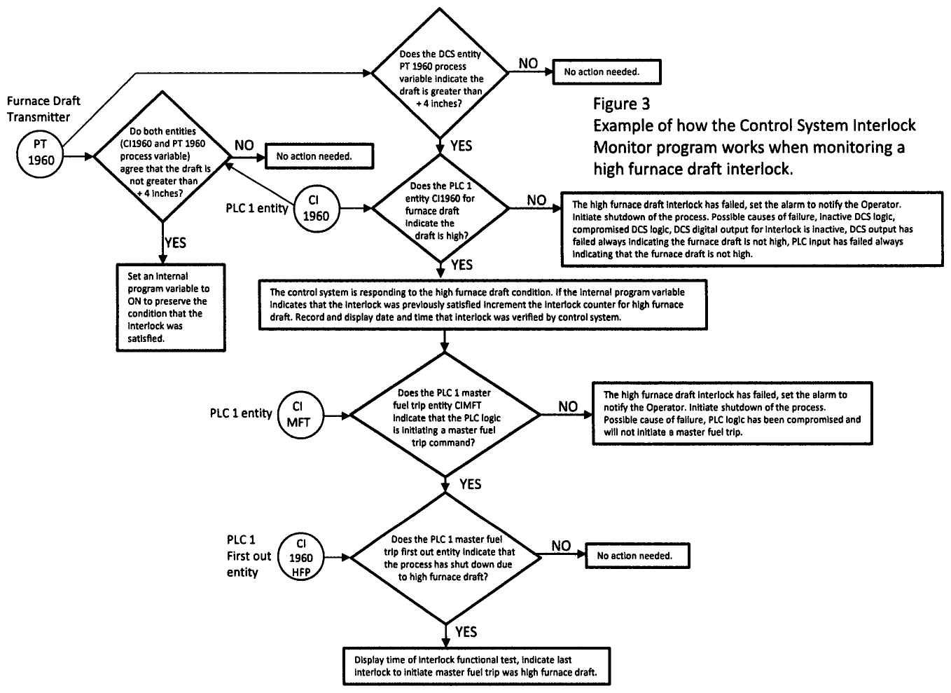

FIG. 3 is a flow chart that represents an example and portion of the created program for monitoring one of the possible interlocks, in this example a high furnace draft interlock is used for explanation.

In this example the program monitors the process variable from DCS entity PT 1960. Whenever the furnace draft is greater than +4″ H2O the program expects the PLC 1 entity for the furnace draft CI 1960 to indicate that the furnace draft is high. By making such a comparison the created program is verifying that the interconnections, control equipment and programming are responding appropriately to the high furnace draft condition. In this particular example the furnace draft process variable is measured by the transmitter PT 1960. The transmitter provides a signal to the DCS which represents the furnace draft. The DCS furnace draft entity is configured for a range of +5″ H2O to −5″ H2O, the process variable can be any value within this configured range. The programmed DCS logic sets a digital output entity based on the value of the PT 1960 process variable and an internal value that represents the high furnace limit. In this example the internal high furnace limit or trip setting value is +4 inches H2O and the state of the digital entity can be ON or OFF, indicating that the draft interlock is NOT HIGH or HIGH.

When the draft is less than +4″ H2O the DCS digital entity process variable state is set to NOT HIGH and when the draft is greater than +4″ H2O the DCS logic sets the DCS digital output entity process variable state equal to HIGH. In this example a DCS digital output entity wired to a PLC 1 input module which provides the draft interlock to PLC 1 processor. The PLC 1 programmed logic reacts to this provided draft interlock by initiating a master fuel trip command when the draft interlock indicates that the draft is HIGH. PLC 1 provides an entity CI1960 to the DCS which represent the PLC 1 state of the draft interlock. By utilizing entities PT 1960 and CI1960 the program has the ability to determine if the DCS logic, DCS hardware, wiring interconnections, PLC 1 hardware and PLC logic is responding to the high furnace draft condition.

The created program has to initially determine if the interlock was satisfied and preserve this condition to enable the created program to determine that the interlock has transitioned to a not satisfied state. For this an internal program variable is used to preserve the interlock satisfied state. The programming for this can be represented as IF PT1960. PV<4.0 AND CI1960. PV=NOT HIGH THEN SET internal variable=ON.

In the example provided, as the furnace draft PT1960 transitions to values above +4″ H2O the created program will increment a counter if the transition is confirmed by the PLC 1 furnace draft entity CI1960. The programming for this can be represented as IF PT1960.PV>4.0 AND CI1960.PV=HIGH THEN SET COUNTER 1=COUNTER 1+COUNTER 1. The counter value is presented to the operator interface to show the number of verified confirmed transitions of the interlock.

For this example, the created program also generates an alarm to notify the Operator that the furnace draft interlock has failed and is judged as not having the ability to generate the master fuel trip (MFT) command. For this alarm function the created program monitors a PLC 1 entity CIMFT which represent the master fuel trip (MFT) command from the PLC 1 logic. Whenever the furnace draft is high the PLC 1 logic must initiate a master trip to stop all fuel firing and close all fuel valves. The created program also creates the same interlock malfunction alarm for a condition of the DCS entity PT1960 indicates the draft is greater than +4″ H2O and the PLC 1 MFT entity CIMFT indicates that the PLC 1 logic has not initiated a MFT. The previous programming for monitoring the draft interlock can be revised to include the MFT entity and can be represented as IF PT1960.PV>4.0 AND (CI1960.PV=NOT HIGH OR CIMFT.PV=NO MFT) THEN SET PT1960A.PV=ALARM. In this example the DCS entity PT1960A is used to notify the Operator that the furnace draft high interlock has malfunctioned. An alarm is generated by the created program for any interlock that has malfunctioned. Alarm indications can also be provided and included in the Operator interface.

The created program may have to include delays to avoid incorrectly indicating that the interlock has malfunctioned. The control system logic for any interlock may include an intentional delay. The control system may also include inherent delays caused by multiple processor program execution time and communications between the processors in use. The created program may need to include delays to accommodate the intentional and inherent delays. Once an interlock malfunction is detected the created program can allow for a delay before initiating an alarm to declare that the interlock has malfunctioned.

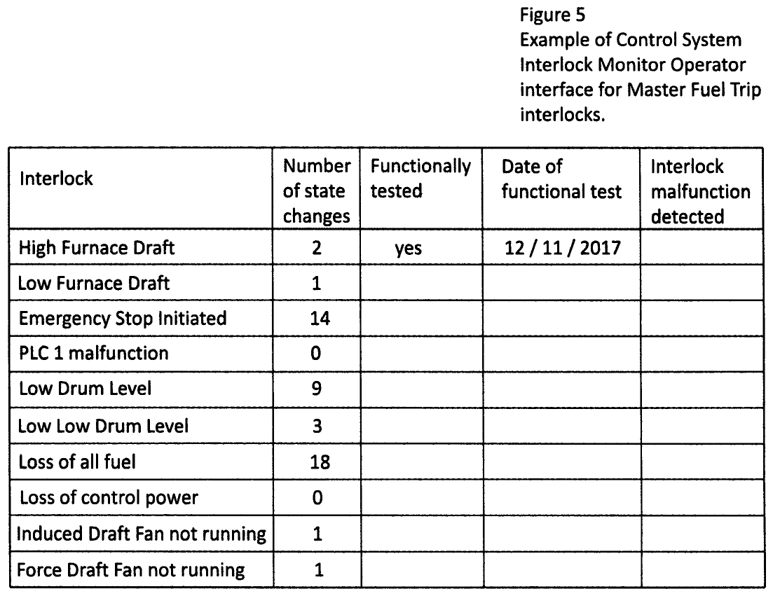

The created program also uses multiple PLC 1 first out entities for two purposes. First to record which interlock was responsible for initiation of the MFT, and second to allow the Operator the ability to reset any of the interlock malfunction alarms. Recording of the MFT first out is important for documenting that the control system has the ability to initiate a MFT all the way through to manipulation of the final controlled equipment, in this example the closing of the fuel valves. For this example FIG. 3 shows the high furnace draft first out entity as CI1960HFP. The created program can also include a feature of storing the control system date and time to document when the control system verified the interlock had initiated the process shutdown, the example shown on FIG. 5 for the Operator interface includes the recorded date feature.

The created program also uses the MFT first outs to allow a reset of the interlock malfunction alarms. In the event an interlock malfunction was detected the created program requires that the first out be present and that all monitored entities agree that the control system is recognizing that a particular the interlock is proving it has the ability to shutdown the process. By confirming all the conditions are true then the created program will reset the interlock malfunction alarm when the Operator initiates a command to reset the alarm. The example for needed programming to reset the furnace draft interlock malfunction alarm could be as follows, IF PT1960.PV>4.0 AND CI1960.PV=HIGH AND CIMFT.PV=MFT AND PT1960A.PV=ALARM AND CI1960FO.PV=ON AND CMALARM.PV=RESET THEN SET PT1960A.PV=NOALARM. For this example, CI1960FO is the high furnace draft interlock MFT first out entity and CMALARM is the Operators control entity which is used to reset the interlock malfunction alarm.

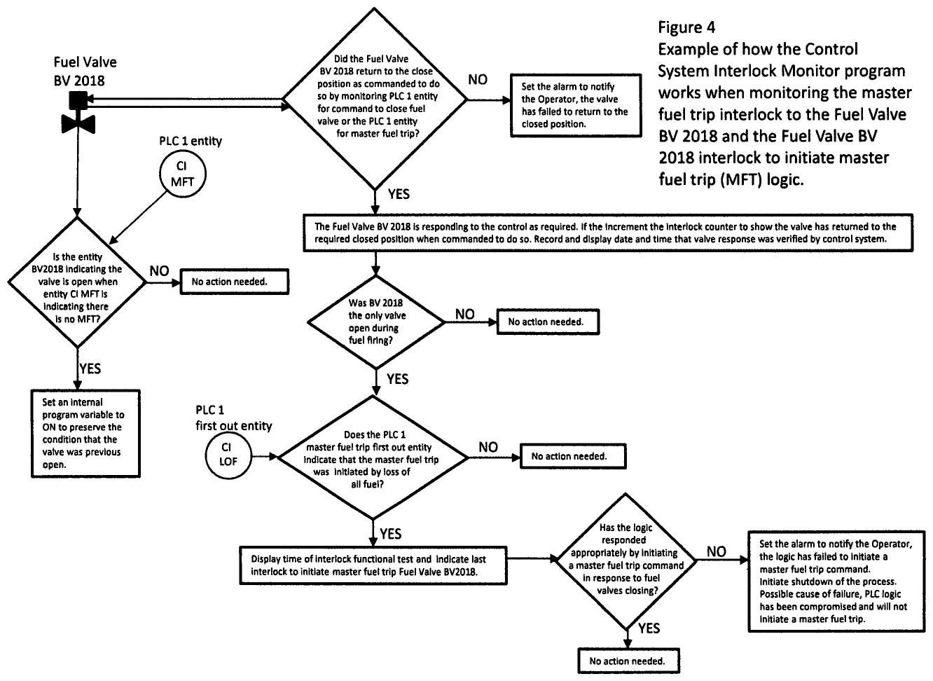

FIG. 4 presents a flow chart that represents a portion of the created program for monitoring the master fuel trip interlock to the fuel valve and the fuel valve interlock to the PLC 1 MFT logic. Unlike the previous example for the furnace draft interlock which used a DCS entity and PLC 1 entities this example uses PLC 1 entities to determine that the interlock has changed state and if the PLC 1 logic responds to this appropriately by initiating a MFT.

For this example, the program monitors the PLC 1 entity ZI2018 which represents the open or closed position of fuel valve BV 2018. The created program compares the PLC 1 entity ZI2018 to the PLC 1 entity representing the PLC 1 commanded state of the valve. The program has to determine and if the valve was open so subsequent execution of the created program can determine if the valve returned to the closed position. For this an internal program variable can be set to ON to preserve the open state of the valve. The programming for this can be represented as IF BV2018.PV=OPEN AND CIMFT.PV=NO MFT THEN SET BV2018PP.PV=OPEN.

The internal variable BV2018PP (BV2018 prior position) is compared to the control system entity BV2018 to determine when the valve position changes from open to closed. The created programming for counting verified position change can be as follows, IF BV2018PP.PV=OPEN AND BV2018.PV=CLOSE AND ZI2018.PV=CLOSE THEN SET COUNTER 2=COUNTER 2+COUNTER 2. Like the previous example the counter value is presented to the operator interface to document verified position changes of the valve.

Like the previous example for the furnace draft interlock the created program also generates an alarm to notify the Operator that the fuel valve has interlock has failed. The failure alarm is generated for two types of failures. First, a failure of the valve to return to the closed position as commanded to do so by PLC 1, and second if closure of all the fuel valves did not result in initiation of the MFT command from the PLC 1 logic.

The created program can use any of the interlock malfunction alarms to generate an alternative shut down command to return the process to a safe state. For this the programmer will create a control system entity that can be set by the created Control System Interlock Monitor program. The programmer will create a connection to the processor that has final determination and control of the equipment to be controlled.

The created program will monitor multiple interlocks including those that are redundant. For control systems that use a voting logic the created program will determine which of the redundant interlocks was responsible for satisfying the interlock or which was responsible for initiating a shutdown of the equipment and process. When voting logic is used the created program can determine the order at which the interlocks are satisfied or not satisfied and therefore can determine which of the three redundant interlocks was responsible for initiating a shutdown of the process equipment or which was responsible for satisfying the overall state of the interlock.

As an alternative, the created program can increment the interlock state change counters when the interlocks transitions from a not satisfied state to a satisfied state. Also, as an alternative the created program can monitor the state of an entity that represents all common interlocks have been satisfied. By monitoring all the interlock entities and the common interlock entity the created program will declare the last interlock satisfied as the interlock that was functionally tested. This is equivalent to satisfying all the interlocks and testing one by causing a state change of that interlock from satisfied to not satisfied.

1. The invention (method) of detecting interlock malfunctions, automation of documenting interlock verification and documentation of interlock functional test provides the following.
Provides continuous monitoring of the control system interlocks.
Determines a proper control system response to an interlock state change.
Counts the number of verified interlock state changes for any of the monitored interlocks.
Determines if there is an improper control system response due to failure of the control system interconnections and utilized equipment.
Determines if there is an improper control system response due to incorrect or improper programming.
Notifies control system Operator of an interlock malfunction and improper control system response.
Determines and documents the first detected common interlock that resulted in safe shutdown of operating equipment.
Initiates an alternate shutdown request that returns the process and equipment to a safe state.
